(19) United States
(12) Patent Application Publication
(10) Pub. No.: US 2022/0252012 A1
(43) Pub. Date: Aug. 11, 2022

(54) FLOWPATH ASSEMBLY WITH COMPOSITE TUBE ARRAY

(71) Applicant: General Electric Company, Schenectady, NY (US)

(72) Inventor: Michael James Verrilli, Loveland, OH (US)

(21) Appl. No.: 17/173,429

(22) Filed: Feb. 11, 2021

(51) Int. Cl. F02C 7/22; F23R 3/28; B29C 70/22; B29C 70/34

(52) U.S. Cl. CPC F02C 7/222; F23R 3/28; B29C 70/222; B29C 70/342; F05D 2220/10; B29L 2023/22; F05D 2240/35; F05D 2300/2261; F05D 2300/6033; F05D 2300/6111; F23R 2900/00018; F05D 2230/314

(57) ABSTRACT

Flowpath assemblies, methods of forming flowpath assemblies, and hypersonic vehicles are provided. For example, a flowpath assembly for a combustor comprises a tube array comprising a plurality of tubes, a joining material disposed between adjacent tubes of the plurality of tubes to join together the adjacent tubes, a flowpath layer, and an outer layer. The plurality of tubes and the joining material are disposed between the flowpath layer and the outer layer. The flowpath layer defines a combustion flowpath. Each of the plurality of tubes, the joining material, the flowpath layer, and the outer layer are formed from a composite material. The combustor comprising the flowpath assembly may be included in a ramjet engine of a hypersonic vehicle. A fabrication method may include laying up composite plies to form a tube array including the plurality of tubes, the joining material, and the flowpath and outer layers.

### FIELD

The present subject matter relates generally to flowpath assemblies, and more particularly, to a combustion flowpath assembly for injection in a vehicle.

### BACKGROUND

Propulsion systems of aircraft and/or engines typically include a flowpath for combustion products. Such combustion flowpaths may experience high temperatures. In particular, high-speed hypersonic propulsion systems and/or engines may facilitate supersonic and hypersonic air transport. Operating at such high speeds creates many issues not present, or less prevalent, in subsonic flight operations. For instance, hypersonic operation may generate a large amount of heat, requiring designs, materials, etc. to mitigate the impacts of high temperatures. More specifically, the combustion flowpath of a hypersonic propulsion system may experience high temperatures that must be taken into consideration when configuring the fuel delivery system. Accordingly, improvements to vehicles such as aircraft and hypersonic propulsion systems for vehicles that help overcome these issues would be useful.

### BRIEF DESCRIPTION

Aspects and advantages of the invention will be set forth in part in the following description, or may be obvious from the description, or may be learned through practice of the invention.

In one exemplary embodiment of the present subject matter, a flowpath assembly for a combustor is provided. The flowpath assembly comprises a tube array comprising a plurality of tubes, a joining material disposed between adjacent tubes of the plurality of tubes to join together the adjacent tubes, a flowpath layer, and an outer layer. The plurality of tubes and the joining material are disposed between the flowpath layer and the outer layer. The flowpath layer defines a combustion flowpath. Each of the plurality of tubes, the joining material, the flowpath layer, and the outer layer are formed from a composite material.

In another exemplary embodiment of the present subject matter, a method of forming a flowpath assembly is provided. The method comprises laying up a plurality of composite plies to form a plurality of composite tubes; partially curing the plurality of composite tubes; embedding the plurality of composite tubes in an assembly of first composite plies having fibers extending in a first direction and second composite plies having fibers extending in a second direction to form a tube array, the first direction orthogonal to the second direction; and partially curing the tube array.

In yet another exemplary embodiment of the present subject matter, a hypersonic vehicle is provided. The hypersonic vehicle comprises a ramjet engine comprising an air inlet, a nozzle, a fuel delivery system comprising a fuel tank, and a combustor disposed between the air inlet and the nozzle. The fuel delivery system provides a flow of a fuel to the combustor, and the combustor includes a flowpath assembly for combustion of the fuel and a flow of combustion products therealong. The flowpath assembly comprises a tube array comprising a plurality of tubes, a joining material disposed between adjacent tubes of the plurality of tubes to join together the adjacent tubes, a flowpath layer, and an outer layer. The plurality of tubes and the joining material are disposed between the flowpath layer and the outer layer. The flowpath layer defines a combustion flowpath. Each of the plurality of tubes, the joining material, the flowpath layer, and the outer layer are formed from a composite material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross-sectional, schematic view of a hypersonic vehicle in accordance with various exemplary embodiments of the present subject matter.

FIG. 2 provides a schematic cross-sectional view of a flowpath assembly, according to an exemplary embodiment of the present subject matter.

FIGS. 3A and 3B provide schematic views of joints for joining two or more tubes or tube segments of the flowpath assembly of FIG. 2.

FIGS. 4 and 5 provide schematic cross-sectional views of flowpath assemblies having a high temperature liner layers, according to exemplary embodiments of the present subject matter.

FIGS. 6A and 6B provide schematic views of exemplary ply configurations for attaching composite fasteners to a tube array of the flowpath assemblies of FIGS. 2, 4, and 5.

FIGS. 7A-7C provide a flow diagram illustrating a method of forming a flowpath assembly, according to an exemplary embodiment of the present subject matter.

FIG. 8 provides a schematic cross-section view of an exemplary tooling assembly for forming composite tubes of a tube array of the flowpath assemblies of FIGS. 2, 4, and 5.

FIGS. 9A and 9B provide a flow diagram illustrating a method of forming a flowpath assembly, according to another exemplary embodiment of the present subject matter.

FIGS. 10A and 10B provide a flow diagram illustrating a method of forming a flowpath assembly, according to yet another exemplary embodiment of the present subject matter.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the word “exemplary” is used herein to mean “serving as an example, instance, or illustration.” Any implementation described herein as “exemplary” is not necessarily to be construed as preferred or advantageous over other implementations. Further, the terms “first,” “second,” and “third” may be used interchangeably to distinguish one component from another and are not intended to signify location or importance of the individual components. The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows. The terms “coupled,” “fixed,” “attached to,” and the like refer to both direct coupling, fixing, or attaching, as well as indirect coupling, fixing, or attaching through one or more intermediate components or features, unless otherwise specified herein. The singular forms “a,” “an,” and “the” include plural references unless the context clearly dictates otherwise.

Further, as used herein, the terms “axial” or “axially” refer to a dimension along a longitudinal axis of an engine. The term “forward” used in conjunction with “axial” or “axially” refers to a direction toward the engine inlet, or a component being relatively closer to the engine inlet as compared to another component. The term “aft” or “rear” used in conjunction with “axial” or “axially” refers to a direction toward the engine exhaust, or a component being relatively closer to the engine exhaust as compared to another component. The terms “radial” or “radially” refer to a dimension extending between a center longitudinal axis (or centerline) of the engine and an outer engine circumference. Radially inward is toward the longitudinal axis and radially outward is away from the longitudinal axis.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. The approximating language may refer to being within a +/−1, 2, 4, 10, 15, or 20 percent margin in either individual values, range(s) of values, and/or endpoints defining range(s) of values.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Generally, the present subject matter is directed to a flowpath assembly comprising a composite tube array. More particularly, the present subject matter is directed to a combustion flowpath assembly of a vehicle, such as a hypersonic aircraft, comprising a composite tube array, such as a ceramic matrix composite (CMC) tube array, for delivering fuel for combustion and providing a flowpath for the flow of combustion products (including the combusted fuel). The composite tube array comprises a plurality of tubes, a joining material disposed between adjacent tubes of the plurality of tubes to join together the adjacent tubes, a flowpath layer, and an outer layer. The plurality of tubes and the joining material are disposed between the flowpath layer and the outer layer, and the flowpath layer defines the flowpath for the flow of combustion products. A plurality of composite materials may be joined to the outer layer of the tube array, e.g., to join the tube array to a metallic back structure. Further, the tube array may include a high temperature liner layer that defines the flowpath and increases the temperature capability of the composite tube array.

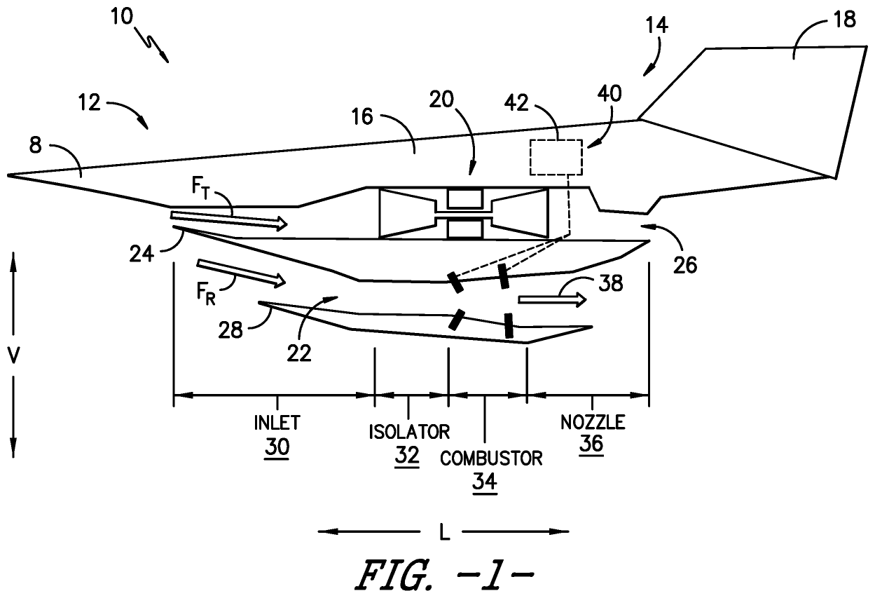

Referring now to the drawings, wherein identical numerals indicate the same elements throughout the figures, FIG. 1 provides a schematic cross-sectional view of a hypersonic vehicle 10 in accordance with an exemplary aspect of the present disclosure. The exemplary hypersonic vehicle 10 of FIG. 1 is a hypersonic aircraft that generally defines a vertical direction V, a lateral direction (not labeled), and a longitudinal direction L. Moreover, the hypersonic vehicle 10 extends between a forward end 12 and an aft end 14 generally along the longitudinal direction L. For the embodiment shown, the hypersonic vehicle 10 includes a nose cone 8, a fuselage 16, a first wing (not shown) extending from a port side of the fuselage 16, a second wing (not shown) extending from a starboard side of the fuselage 16, and a vertical stabilizer 18.

The hypersonic vehicle 10 includes a propulsion system, which for the embodiment shown includes a turbomachine 20 and a ramjet 22 (or scramjet 22, i.e., a supersonic combustion ramjet 22). The turbomachine 20 includes a ram air entrance door 24 and an exhaust 26. An airflow FT can pass through the turbomachine 20 and propel the hypersonic vehicle 10 forward. The ramjet 22 includes a ramjet entrance door 28, an inlet 30, an isolator 32, a combustor 34, and a ramjet exhaust 36. When active, the ramjet entrance door 28 is open to allow an airflow F_{R} to enter the inlet 30 and flow through the isolator 32 to the combustor 34. Fuel is injected in the combustor 34, mixes with the airflow F_{R}, and the fuel-air mixture combusts to form a flow of combustion products 38. A fuel delivery system 40, including a fuel tank 42, may provide fuel to the combustor 34; the injection of the fuel in the combustor 34 is described in greater detail below. Further, as shown in FIG. 1, the ramjet exhaust 36 is configured as a nozzle and, thus, also may be referred to as nozzle 36. Accordingly, the flow of combustion products 38 expands through the nozzle or exhaust 36, providing thrust to propel the hypersonic vehicle 10 forward. In certain instances, the turbomachine 20 and ramjet 22 can operate concurrently. In other instances, the turbomachine 20 and ramjet 22 can operate independent of one another.

As will be appreciated, the hypersonic vehicle 10 is for use at high speeds (e.g., speeds greater than 3800 MPH), and as such, the propulsion system may be configured for propelling the hypersonic vehicle 10 from takeoff (e.g., 0 miles per hour up to around 250 miles per hour) up and to hypersonic flight. It will be appreciated, that as used herein, the term “hypersonic” refers generally to air speeds of about Mach 3 up to about Mach 10, such as Mach 5 and up.

Further, the particular hypersonic vehicle 10 depicted in FIG. 1 is an aerospace vehicle or aircraft; however, it should be understood that the present subject matter may be applicable to other vehicles in accordance with embodiments described herein. Moreover, the exemplary hypersonic vehicle 10 depicted in FIG. 1 is provided by way of example only, and in other embodiments may have any other suitable configuration. For example, in other embodiments, the nose cone 8, fuselage 16, and/or vertical stabilizer 18 may have any other suitable shape (such as a more pointed, aerodynamic shape, different stabilizer shapes and orientation, etc.), the propulsion system may have any other suitable engine arrangement (e.g., an engine incorporated into the vertical stabilizer), and/or any other suitable configuration. Further, the hypersonic vehicle 10 may have various modes of operation, e.g., the hypersonic vehicle 10 be a manned or unmanned vehicle.

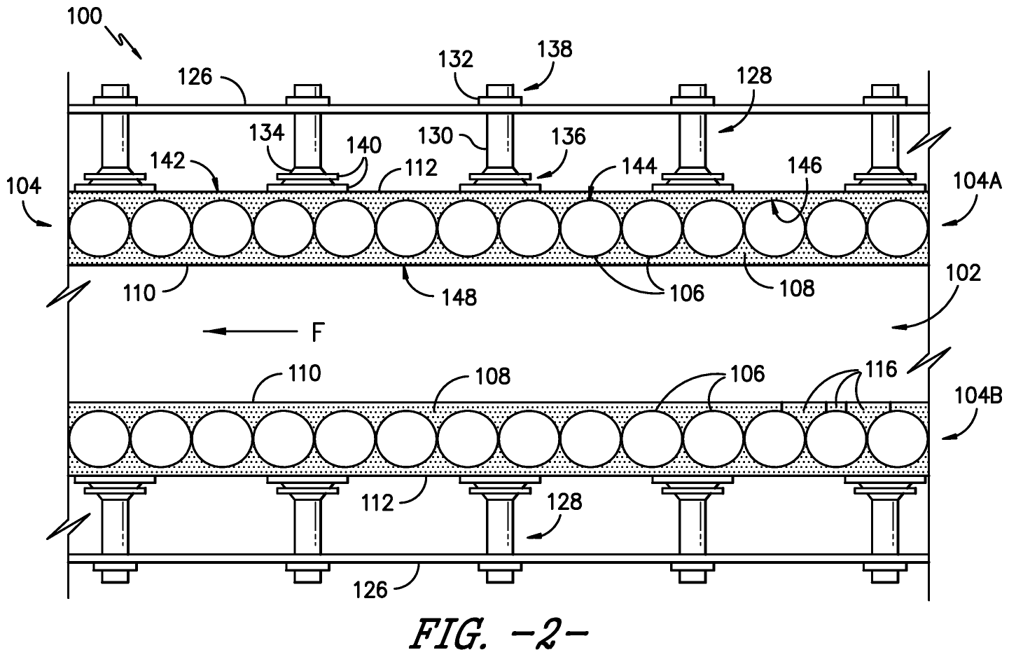

Turning now to FIG. 2, the present subject matter also provides a flowpath assembly 100. In exemplary embodiments, the flowpath assembly 100 is incorporated into the combustor 34 of the hypersonic vehicle 10, receiving fuel from the fuel delivery system 40 and defining a flowpath 102 for the combustion products 38 through the combustor 34, such that the flowpath 102 may be referred to as the combustion flowpath 102. More particularly, an exemplary flowpath assembly 100 defining the combustion flowpath 102 comprises a tube array 104 for injecting fuel, e.g., from the fuel delivery system 40 of the hypersonic vehicle 10, into a combustor, e.g., the combustor 34 of the hypersonic vehicle 10. The tube array 104 comprises a plurality of tubes 106, a joining material 108 disposed between adjacent tubes 106 to join together the adjacent tubes 106, a flowpath layer 110, and an outer layer 112. As shown in the figures, the plurality of tubes 106 and the joining material 108 are disposed between the flowpath layer 110 and the outer layer 112, and the flowpath layer 110 defines the combustion flowpath 102. Further, as described in greater detail herein, each of the plurality of tubes 106, the joining material 108, the flowpath layer 110, and the outer layer 112 are formed from a composite material, such as a ceramic matrix composite (CMC).

It will be appreciated that, as used herein, the term “tube” means a hollow, generally cylindrical component for holding or transporting fluids. As described herein, the plurality of tubes 106 primarily are configured for transporting a fluid. For instance, in exemplary embodiments, the plurality of tubes 106 are configured for injecting fuel into a combustor of a ramjet or scramjet engine, such as the combustor 34 of the ramjet engine 22 of hypersonic vehicle 10. The fuel may be liquid hydrogen (LH2 or the refrigerant designation R-702), methane (R-50), jet fuel or jet propellant (JP), or any other suitable fuel.

Keeping with FIG. 2, in exemplary embodiments, the tube array 104 comprises a first tube array 104A and a second tube array 104B. The plurality of tubes 106 are divided between the first tube array 104A and the second tube array 104B, and the first tube array 104A is spaced apart from the second tube array 104B such that the combustion flowpath 102 is defined therebetween. As will be appreciated from FIG. 2, the first and second tube arrays 104A, 104B extend parallel to one another such that the tubes 106 in the first tube array 104A are axially aligned with the tubes 106 in the second tube array 104B. Further, as shown in FIG. 2, joining material 108 joins the tubes 106 in the first tube array 104A, and joining material 108 joins the tubes 106 in the second tube array 104B. Moreover, each of the first tube array 104A and the second tube array 104B includes both the flowpath layer 110 and the outer layer 112, with the tubes 106 and the joining material 108 of the respective tube array 104A, 104B disposed between the respective flowpath layer 110 and outer layer 112. As illustrated, the flowpath layer 110 of each of the first tube array 104A and the second tube array 104B defines the combustion flowpath 102.

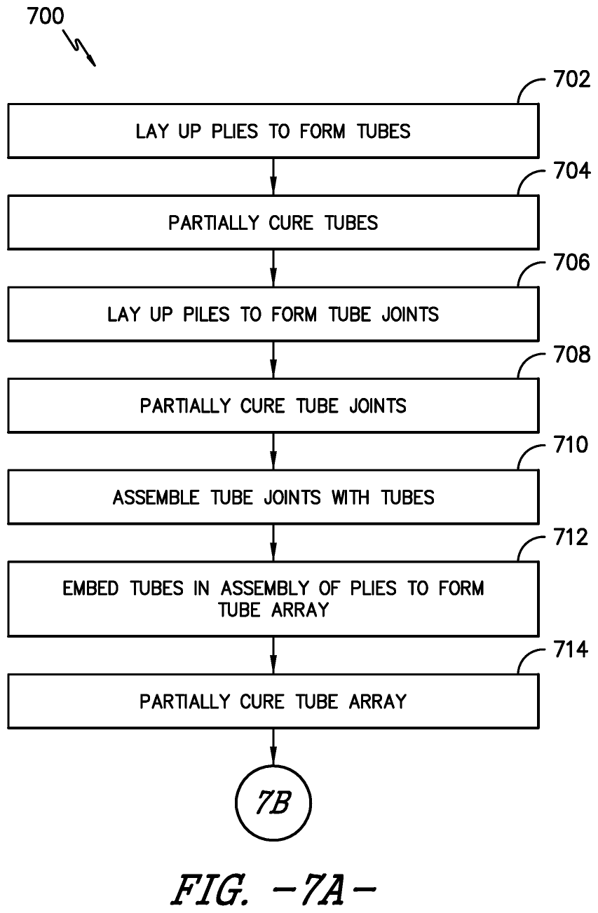

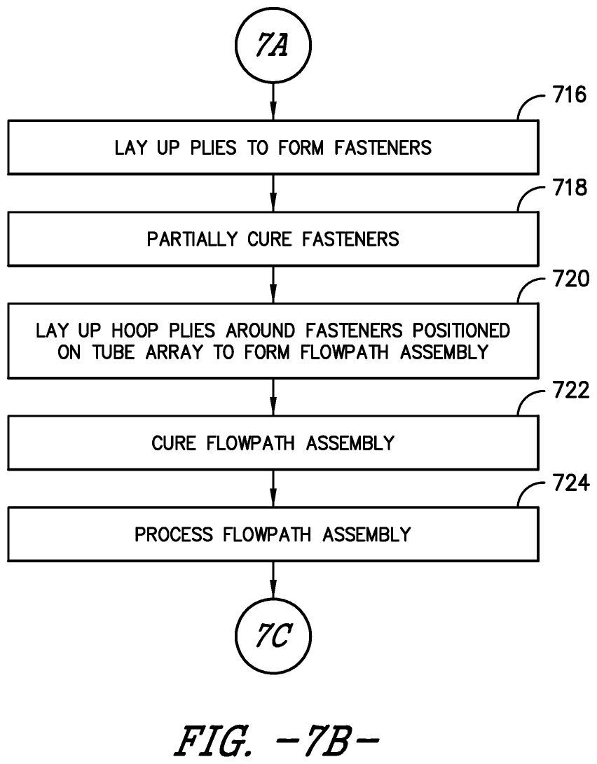

In some embodiments, such as illustrated in FIGS. 6A and 6B, the joining material 108 comprises a plurality of individual composite plies 114, which each comprise a plurality of fibers. The individual composite plies 114 may be rolled up, e.g., to form a noodle, such that the fibers of the composite plies 114 may be disposed between the tubes 106 and generally extend longitudinally with respect to the tubes 106. In other embodiments, the joining material 108 comprises a plurality of filler packs 116, which may each comprise a plurality of rolled up plies, chopped fiber within a matrix, or any other appropriate material. It should be appreciated that, in general, the filler packs 116 may be formed from any suitable material and/or by using any suitable process, e.g., each filler pack 116 may be formed from a suitable fiber-reinforced composite material, such as a carbon or glass fiber-reinforced composite material. For instance, one or more fabric plies may be wrapped in a suitable manner to form one or more filler packs 116 defining a shape complementary to the outer surface 144 of a tube 106. In another embodiment, discontinuous materials, such as short or chopped fibers, particulates, platelets, whiskers, etc., may be dispersed throughout a suitable matrix material and used to form each filler pack 116. Each filler pack 116 may correspond to a prefabricated component and, as such, may be installed in the tube array 104 during or following manufacture of the tubes 106, as described in greater detail herein.

In still other embodiments, the joining material 108 of the tube array 104 may comprise both individual composite plies 114 and filler packs 116. In any event, the individual composite plies 114 and/or the filler packs 116 may be positioned such that the tubes 106 are embedded within the plies 114 and/or filler packs 116, with the plies 114 and/or filler packs 116 surrounding the tubes 106 such that the tubes 106 are surrounded by the fibers of the composite material.

Further, the flowpath layer 110 and the outer layer 112 may each be formed from a plurality of composite plies 114 and may be laid up with the joining material 108 such that the joining material 108 and the layers 110, 112 have different orientations. More particularly, in exemplary embodiments, the joining material 108 comprises a first plurality of fibers and the flowpath layer 110 and the outer layer 112 each comprise a second plurality of fibers. When laid up to form the tube array 104, the first plurality of fibers is disposed along a different orientation than the second plurality of fibers. For instance, the first plurality of fibers may be disposed orthogonal to the second plurality of fibers, e.g., the first plurality of fibers of the joining material 108 may extend along a 0° direction, and the second plurality of fibers of each of the flowpath layer 110 and the outer layer 112 may extend along a 90° direction. A 0°/90° orientation for the joining material 108 fibers and the flowpath layer 110 and outer layer 112 fibers may be desirable, e.g., where plies forming the tubes 106 are disposed such that the ply fibers extend along +45°/−45° directions, but the 0°/90° orientations may be used with other tube ply fiber orientations as well. Also, it will be appreciated that the first plurality of fibers (i.e., joining material 108 fibers) and the second plurality of fibers (i.e., flowpath layer 110 and outer layer 112 fibers) may have other orientations as well, such as a +45°/−45° orientation or any other suitable orientation.

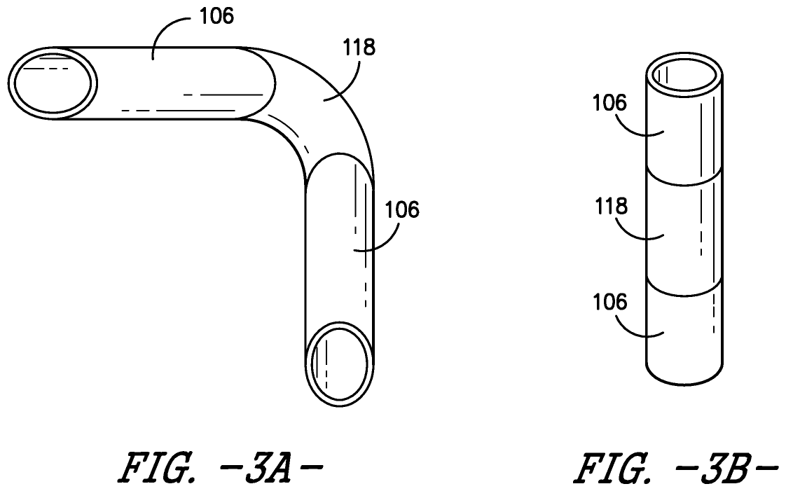

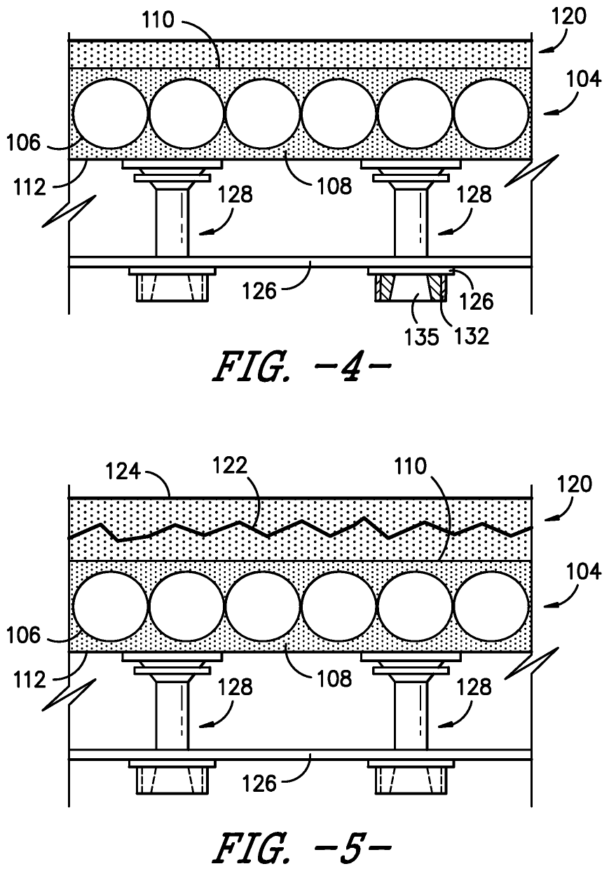

Referring now to FIGS. 3A and 3B, in some embodiments, the tube array 104 comprises a plurality of composite joints 118. For example, as illustrated in FIG. 3A, the composite joints 118 may join the plurality of composite tubes 106 of the first tube array 104A to the plurality of composite tubes 106 of the second tube array 104B. As another example, illustrated in FIG. 3B, the composite joints 118 may join together segments of the tubes 106, e.g., to form a composite tube 106 having a desired length. That is, in some embodiments, the tubes 106 need to be longer or have a different shape than is feasible for a ply layup, processing, etc. to form the composite tubes 106. Accordingly, composite joints 118 may be used to join the tubes 106 or tube segments to define composite tubes 106 having a desired or required shape, length, etc. Methods of forming the tubes 106 are described in greater detail below.

In exemplary embodiments, the plurality of composite joints 118 are formed separately from the plurality of composite tubes 106. Methods for forming the joints 118 and assembling the joints 118 with the tubes 106 are described in greater detail herein. Further, it will be appreciated that the shape of the composite joints 118 illustrated in FIGS. 3A and 3B is by way of example only, and the composite joints 118 may have any suitable shape for joining together two or more composite tubes 106. For instance, to join the first tube array 104A to the second tube array 104B as illustrated in FIG. 2, the composite joints 118 may be generally semi-circular in shape.

As previously stated, in exemplary embodiments, the composite material from which the tubes 106, joining material 108, flowpath layer 110, and outer layer 112 are formed is a ceramic matrix composite (CMC) material. Exemplary CMC materials may include silicon carbide (SiC), silicon, silica, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., 3M's Nextel 440 and 480), and chopped whiskers and fibers (e.g., 3M's Nextel 440 and SAFFIL®), and optionally ceramic particles (e.g., oxides of Si, Al, Zr, Y, and combinations thereof and carbides such as BC and SiC) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., as plies) to form a preform component. The bundles of fibers may be impregnated with a slurry composition prior to forming the preform or after formation of the preform. The preform may then undergo thermal processing, such as a cure or burnout to yield a high char residue in the preform, and subsequent chemical processing, such as melt infiltration with silicon, to arrive at a component formed of a CMC material having a desired chemical composition. In other embodiments, the CMC material may be formed as, e.g., a carbon fiber cloth rather than as a tape. In exemplary embodiments, the composite material is a silicon carbide fiber reinforced silicon carbide matrix (SiC/SiC) CMC, and the tubes 106, joining material 108, flowpath layer 110, and outer layer 112 may each be formed from SiC/SiC plies 114, a SiC woven cloth impregnated with a SiC matrix, SiC/SiC filler packs 116, etc. CMC materials and processes for forming CMC components, such as the flowpath assembly 100, are described in greater detail below.

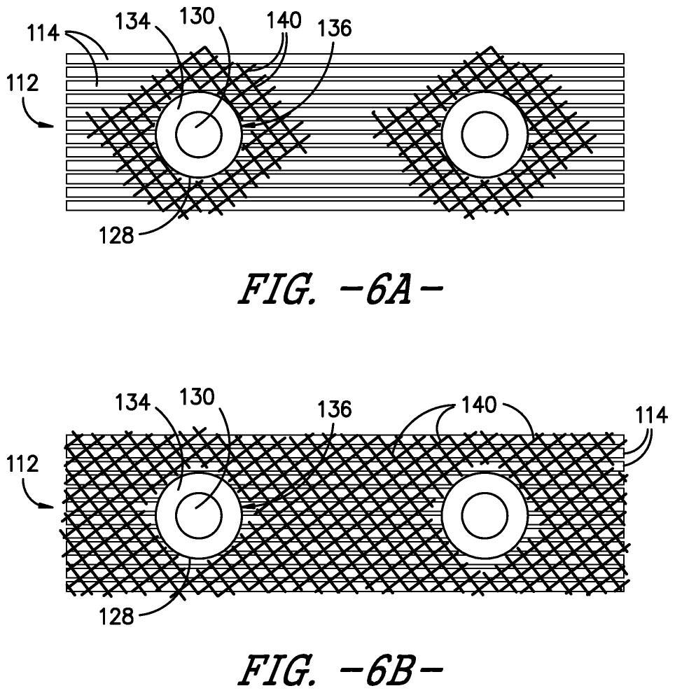

Turning now to FIG. 4, the tube array 104 further comprises a liner layer 120 comprising a high temperature SiC/SiC CMC material. That is, the composite material forming the liner layer 120 may resist higher temperatures than the composite material from which the tube array 104 is formed. As shown in FIG. 5, rather than a high temperature SiC/SiC CMC liner layer 120, the liner layer 120 may comprise a woven ceramic fiber cloth 122 and a coating 124 that coats a surface of the woven ceramic fiber cloth exposed to the combustion flowpath 102. The coating 124 increases the environmental protection provided to the flowpath assembly 100 by the liner layer 120, e.g., the reduces oxidation or other undesirable reactions in the flowpath assembly 100. The coating 124 may be, e.g., a carbide and/or oxide-based coating such as silicon carbide (SiC), hafnium carbide, boron carbide, hafnium oxide, zirconia oxide, etc. The liner layer 120 comprising woven ceramic fiber cloth 122 and coating 124 also may resist higher temperatures than the composite material from which the tube array 104 is formed. That is, in the embodiment of either FIG. 4 or FIG. 5, the liner layer 120 is capable of withstanding higher temperatures than the composite material from which the flowpath layer 110 is made.

For example, the tube array 104 may be formed from a first composite material, such as a first SiC/SiC CMC material, suitable for use in environments of at least 1500° F., such as environments of about 2000° F., about 2200° F., and/or about 2400° F. The liner layer 120 may be formed from a second composite material, such as a second SiC/SiC CMC material or a woven ceramic fiber cloth 122, which may be coated with a coating 124, suitable for use in environments of at least 2500° F., such as about 2600° F., about 2700° F., and/or about 2800° F. As shown in FIGS. 4 and 5, the liner layer 120 is disposed on the flowpath layer 110 such that the flowpath layer 110 is positioned between the liner layer 120 and the plurality of tubes 106. Accordingly, the liner layer 120, rather than the flowpath layer 110 as shown in FIG. 2, is exposed to the combustion flowpath 102 and the combustion products 38 flowing therealong. Thus, the flowpath assembly 100 may include the liner layer 120 to meet flowpath temperature requirements, e.g., for particular hypersonic vehicle 10 designs having combustion flowpath temperatures above the suitable environment temperature of the composite material forming the tube array 104.

Referring to FIGS. 2, 4, and 5, the flowpath assembly 100 may further comprises a metallic back structure 126. The metallic back structure 126 helps support the flowpath assembly 100 within the engine in which the flowpath assembly 100 is installed, e.g., within the ramjet engine 22. As illustrated, the metallic back structure 126 is coupled to the tube array 104 adjacent the outer layer 112 such that the tube array 104 is disposed between the metallic back structure 126 and the combustion flowpath 102. A plurality of composite fasteners 128, e.g., CMC fasteners 128, may be used to couple the metallic back structure 126 to the tube array 104. For instance, the fasteners 128 may be CMC fasteners 128 configured as bolts, having a threaded shaft 130 and a CMC nut 132 that threads onto the threaded shaft 130 to secure the metallic back structure 126 with respect to the CMC fastener 128. Each composite fastener 128 also may include a flared head 134, i.e., a head 134 that increases in circumference from the shaft 130 to a proximal end 136 of the fastener 128. In other embodiments, the shaft 130 of the composite fastener 128 may be unthreaded and have a flared shank 135 opposite the head 134, which may be flared or unflared, with a metallic nut 132 that is received on the flared shank 135 to secure the metallic back structure 126. That is, the fastener 128 may increase in circumference from the shaft 130 to a distal end 138 of the fastener 128, with a metallic nut 132 received at the distal end 138. The metallic nut 132 may have a split threaded sleeve configuration, where a first portion of the split sleeve, having threads about its outer surface, is fitted to the fastener 128 and a second portion of the split sleeve, having threads about an inner surface, is threaded onto the first portion of the split sleeve. Of course, other fastener 128 configurations may be used as well.

The head 134 of each CMC fastener 128 is joined to the outer layer 112 of the tube array 104, i.e., the proximal end 136 of the CMC fastener 128 is joined to the tube array 104 at the outer layer 112. As such, the flared head 134, having a larger cross-sectional area at the proximal end 136 of the fastener 128, may provide a better contact area with the outer layer 112 than if the head 134 had the same cross-sectional area as the shaft 130. More particularly, the head 134 of each fastener 128 may be shaped to provide better contact with the outer layer 112, e.g., the head 134 may have a different cross-sectional area, a different shape, etc. than a remainder of the fastener 128 to increase the contact between the fastener 128 and the tube array 104. Further, a plurality of hoop plies 140 may be used to join each CMC fastener 128 to the outer layer 112. The plurality of hoop plies 140 may be formed from a CMC material.

As shown in FIG. 6A, the hoop plies 140 may be locally dispersed about a respective CMC fastener 128. That is, the hoop plies 140 may be positioned only about each CMC fastener 128. Referring to FIG. 6B, in other embodiments, the hoop plies 140 may be distributed over an outer surface 142 of the entire outer layer 112 to join the CMC fasteners 128 to the tube array 104.

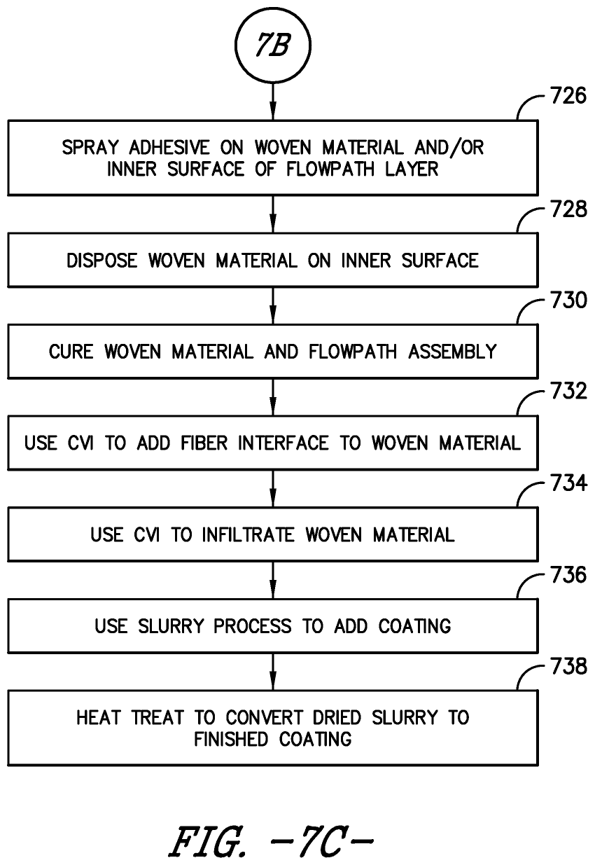

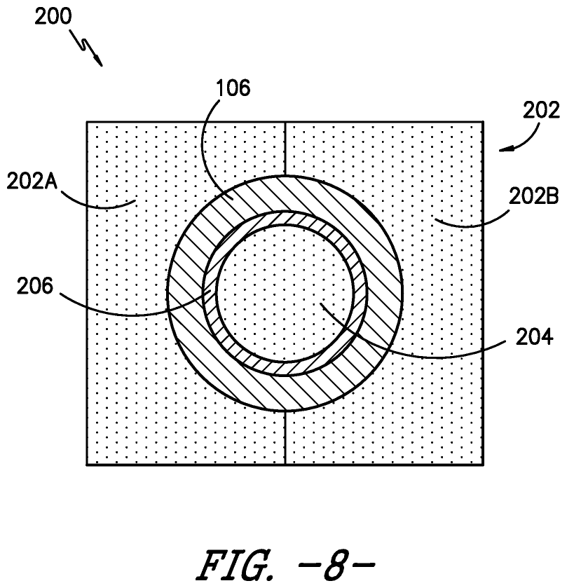

The present subject matter also includes various methods of forming a flowpath assembly, such as the flowpath assembly 100. Referring to FIGS. 7A, 7B, and 7C, a flow diagram is provided illustrating a method 700 of forming a flowpath assembly, according to an exemplary embodiment of the present subject matter. As shown at block 702 in FIG. 7A, the exemplary method 700 includes laying up a first plurality of composite plies to form a plurality of composite tubes, e.g., laying up composite plies 114 to form a plurality of composite tubes 106. In exemplary embodiments, the first plurality of composite plies 114 may be laid up along a +45° direction and a −45° direction, alternating between +45° and −45° plies. Such a +45°/−45° ply orientation may be easier to wrap the plies 114 to form the tube shape, e.g., particularly for relatively small diameter tubes 106. However, other ply orientations may be used as well, such as 0°/90° ply orientations, any combination of 0°/−45°/+45°/90° ply orientations, or any other orientation or combination of orientations. Moreover, the number of plies 114 used to form the composite tubes 106 may be selected to achieve a desired hoop strength, flex strength, and/or tensile strength, to minimize or eliminate fluid leakage from the tubes 106, etc. For example, the number of plies 114 laid up to define each tube 106 may be selected to provide sufficient strength to the tube 106 to convey fuel, e.g., to a ramjet engine combustor such as combustor 34, while also minimizing or eliminating leakage of the fuel.

Further, as described herein, in exemplary embodiments, the composite plies 114 may be formed from a ceramic matrix composite (CMC) material. For instance, the composite plies 114 may be formed from a silicon carbide (SiC) material such that each tube 106 of the plurality of tubes 106 is formed from a SiC/SiC CMC material. Examples of CMC materials, and particularly SiC/Si—SiC (fiber/matrix) continuous fiber-reinforced ceramic composite (CFCC) materials and processes, are described in U.S. Pat. Nos. 5,015,540; 5,330,854; 5,336,350; 5,628,938; 6,024,898; 6,258,737; 6,403,158; and 6,503,441, and U.S. Patent Application Publication No. 2004/0067316. Such processes generally entail the fabrication of CMCs using multiple pre-impregnated (prepreg) layers, e.g., the ply material may include prepreg material consisting of ceramic fibers, woven or braided ceramic fiber cloth, or stacked ceramic fiber tows that has been impregnated with matrix material. As previously described, in some embodiments, each prepreg layer is in the form of a tape comprising the desired ceramic fiber reinforcement material, one or more precursors of the CMC matrix material, and organic resin binders. Prepreg tapes can be formed by impregnating the reinforcement material with a slurry that contains the ceramic precursor(s) and binders. Preferred materials for the precursor will depend on the particular composition desired for the ceramic matrix of the CMC component, for example, SiC powder and/or one or more carbon-containing materials if the desired matrix material is SiC. Notable carbon-containing materials include carbon black, phenolic resins, and furanic resins, including furfuryl alcohol (C₄H₃OCH₂OH). Other typical slurry ingredients include organic binders (for example, polyvinyl butyral (PVB)) that promote the flexibility of prepreg tapes, and solvents for the binders (for example, toluene and/or methyl isobutyl ketone (MIBK)) that promote the fluidity of the slurry to enable impregnation of the fiber reinforcement material. The slurry may further contain one or more particulate fillers intended to be present in the ceramic matrix of the CMC component, for example, silicon and/or SiC powders in the case of a Si—SiC matrix. Chopped fibers or whiskers or other materials also may be embedded within the matrix as previously described. Other compositions and processes for producing composite articles, and more specifically, other slurry and prepreg tape compositions, may be used as well, such as, e.g., the processes and compositions described in U.S. Patent Application Publication No. 2013/0157037.

The resulting prepreg tape may be laid-up with other tapes, such that a CMC component formed from the tape comprises multiple laminae, each lamina derived from an individual prepreg tape. Each lamina contains a ceramic fiber reinforcement material encased in a ceramic matrix formed, wholly or in part, by conversion of a ceramic matrix precursor, e.g., during firing and densification cycles as described more fully below. In some embodiments, the reinforcement material is in the form of unidirectional arrays of tows, each tow containing continuous fibers or filaments. Alternatives to unidirectional arrays of tows may be used as well. Further, suitable fiber diameters, tow diameters, and center-to-center tow spacing will depend on the particular application, the thicknesses of the particular lamina and the tape from which it was formed, and other factors. As described above, other prepreg materials or non-prepreg materials may be used as well.

After laying up the tapes or plies to form a layup, the layup is debulked and, if appropriate, cured while subjected to elevated pressures and temperatures to produce a preform. The preform is then heated (fired) in a vacuum or inert atmosphere to decompose the binders, remove the solvents, and convert the precursor to the desired ceramic matrix material. Due to decomposition of the binders, the result is a porous CMC body that may undergo densification, e.g., melt infiltration (MI), to fill the porosity and yield the CMC component. Specific processing techniques and parameters for the above process will depend on the particular composition of the materials. For example, silicon CMC components may be formed from fibrous material that is infiltrated with molten silicon, e.g., through a process typically referred to as the Silcomp process. Another technique of manufacturing CMC components is the method known as the slurry cast melt infiltration (MI) process. In one method of manufacturing using the slurry cast MI method, CMCs are produced by initially providing plies of balanced two-dimensional (2D) woven cloth comprising silicon carbide (SiC)-containing fibers, having two weave directions at substantially 90° angles to each other, with substantially the same number of fibers running in both directions of the weave. The term “silicon carbide-containing fiber” refers to a fiber having a composition that includes silicon carbide, and preferably is substantially silicon carbide. For instance, the fiber may have a silicon carbide core surrounded with carbon, or in the reverse, the fiber may have a carbon core surrounded by or encapsulated with silicon carbide.

Other techniques for forming CMC components include polymer infiltration and pyrolysis (PIP) and oxide/oxide processes. In PIP processes, silicon carbide fiber preforms are infiltrated with a preceramic polymer, such as polysilazane and then heat treated to form a SiC matrix. In oxide/oxide processing, aluminum or alumino-silicate fibers may be pre-impregnated and then laminated into a preselected geometry. Components may also be fabricated from a carbon fiber reinforced silicon carbide matrix (C/SiC) CMC. The C/SiC processing includes a carbon fibrous preform laid up on a tool in the preselected geometry. As utilized in the slurry cast method for SiC/SiC, the tool is made up of graphite material. The fibrous preform is supported by the tooling during a chemical vapor infiltration (CVI) process at about 1000° C. to 1200° C., whereby the C/SiC CMC component is formed. In still other embodiments, 2D, 2.5D, and/or 3D preforms may be utilized in MI, CVI, PIP, or other processes. For example, cut layers of 2D woven fabrics may be stacked in alternating weave directions as described above, or filaments may be wound or braided and combined with 3D weaving, stitching, or needling to form 2.5D or 3D preforms having multiaxial fiber architectures. Other ways of forming 2.5D or 3D preforms, e.g., using other weaving or braiding methods or utilizing 2D fabrics, may be used as well.

Returning to the exemplary method 700 illustrated in FIGS. 7A-7C, after laying up the composite plies as shown at block 702, the method includes at block 704 partially curing the plurality of composite tubes 106. In exemplary embodiments, partially curing the plurality of composite tubes 106 comprises autoclaving the composite tubes 106 to a temperature within a range of about 200° F. to about 400° F., and more particularly, within a range of about 300° F. to about 375° F., until the composite tubes 106 are mostly cured. As one example, the plurality of composite tubes 106 may be autoclaved at a temperature of about 200° F. to about 500° F. until the composite tubes 106 are mostly cured. Accordingly, the composite tubes 106 may be cured at a lower temperature than a standard autoclave cycle. Thus, the composite tubes 106 may retain some flexibility and malleability, which may help in laying up, e.g., the plies 114 forming the joining material 108 and/or the flowpath and outer layers 110, 112.

It will be appreciated that, while partially curing the composite tubes 106, the composite tubes 106 also are compacted or debulked. For instance, as part of the autoclave process, the composite tubes 106 may undergo both compaction and curing, i.e., compaction within an autoclave at a temperature within the range of about 200° F. to about 500° F. Compaction may help consolidate the composite plies 114 forming the composite tubes 106.

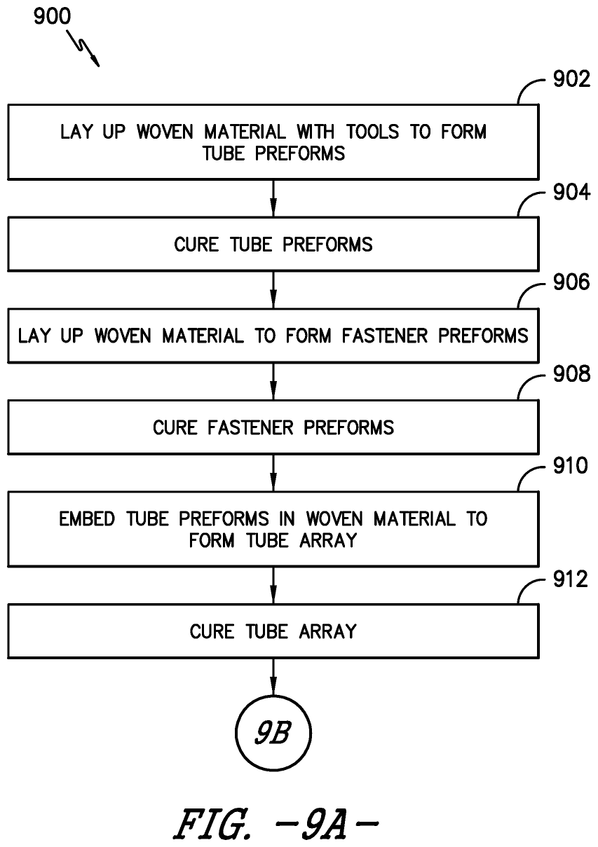

In some embodiments, the compaction or autoclave pressure may be applied on an inner diameter of each tube 106, e.g., to avoid wrinkling of the composite plies 114 that may occur when the compaction pressure is applied on the outer diameter. Referring to FIG. 8, a cross-sectional view is provided of a composite tube 106 within autoclave tooling including a bladder for providing pressure on the inner diameter of the tube 106, according to an exemplary embodiment of the present subject matter. As depicted in FIG. 8, the autoclave tooling 200 includes an external tool 202 that is split into two halves, a first half 202A and a second half 202B. The autoclave tooling further includes an internal tool 204 and a bladder 206. The external and internal tools 202, 204 may be formed from a metallic material, such as steel.

As shown in FIG. 8, the external tool 202 fits around an outer surface 144 of the composite tube 106 and may be formed to the outer dimensions of the tube 106, i.e., the external tool 202 may define a cavity for the tube 106 that is dimensioned according to the desired outer dimensions of the tube 106. The bladder 206 and internal tool 204 are inserted within the composite tube 106 such that the bladder 206 is disposed between the internal tool 204 and an inner surface 146 of the tube 106. In some embodiments, the bladder 206 is cast on the internal tool 204. Further, in some embodiments, the internal tool 204 may be removed after autoclaving (where the tube 106 is compacted and partially cured), but in other embodiments, the internal tool 204 may be removed before autoclaving. The bladder 206 may be formed from a material such as Mosites rubber (by Mosites Rubber Company, Inc. of Fort Worth, Tex.), a room-temperature-vulcanizing (RTV) silicone rubber (e.g., Momentive® RTV664), or the like. When the autoclave tooling 200 is assembled, e.g., as shown in the cross-sectional view of FIG. 8, the bladder 206 may protrude from opposing ends of the tooling 200 such that an autoclave bag may be sealed around the bladder 206 where it protrudes from the ends of the tooling 200. Sealing the bladder 206 in this manner directs the autoclave pressure into the bladder, which causes compaction pressure on the inner diameter or inner surface 146 of the composite tube 106 to compact the tube 106. Compacting the composite tubes 106 in this manner, i.e., by applying pressure on the inner diameter of the tubes 106, may help reduce variance in the inner diameter between tubes 106 and/or with respect to a desired inner diameter for the tubes 106 such that the tubes 106 more consistently have a constant cross-section (in terms of shape, area, etc.) compared, e.g., to tubes 106 compacted by other processes such as from the outside or outer diameter of the tubes 106.

Referring back to FIG. 7A, as illustrated at block 706, the exemplary method 700 further includes laying up a plurality of composite plies to form one or more composite joints 118, e.g., for joining together composite tubes 106 and/or segments thereof as described herein. The composite plies, such as plies 114, used to form the composite joints 118 may be laid up as described with respect to laying up the composite tube plies. For instance, the composite plies 114 may be laid up in an alternating +45°/−45° ply orientation, which may be easier to wrap the plies 114 to form the tubular joint shape, e.g., particularly for relatively small diameter joints 118 used to join relatively small diameter tubes 106. However, other ply orientations may be used as well, such as 0°/90° ply orientations, any combination of 0°/−45°/+45°/90° ply orientations, or any other orientation or combination of orientations. Moreover, the number of plies 114 used to form the composite joints 118 may be selected to achieve a desired hoop strength, flex strength, and/or tensile strength, to minimize or eliminate fluid leakage from the joints 118, etc. Further, the joints 118 may be formed from a suitable composite material, such as a CMC material. In exemplary embodiments, the composite joints 118 may be formed from the same CMC material as the composite tubes 106, e.g., the plurality of composite tubes 106 and the composite joints 118 may each be formed from the same composite plies 114.

As shown at block 708, after laying up the plies to define the composite joints 118, the exemplary method 700 includes partially curing the composite joints 118. As described with respect to the composite tubes 106, partially curing the composite joints 118 may comprise autoclaving the composite joints 118 to a temperature within a range of about 200° F. to about 500° F. until the composite joints 118 are mostly cured. In any event, partially curing the composite material generally comprises curing the composite component (e.g., the composite tubes 106, composite joints 118, etc.) at a lower temperature, e.g., at a lower temperature than is used in a standard autoclave cycle. Thus, the partially cured composite joints 118 may retain some flexibility and malleability, which may help in assembling the composite joints 118 with the composite tubes 106, as shown at block 710 of method 700. That is, the composite joints 118 may be joined with two or more composite tubes 106 and/or two or more composite tube segments as described herein, e.g., to form a longer composite tube 106, to join the tubes 106 in the first tube array 104A with the tubes 106 in the second tube array 104B, etc.

Continuing with FIG. 7A, at block 712, the method 700 includes embedding the plurality of composite tubes 106 in an assembly of a second plurality of composite plies, which plies have fibers extending in a first direction, and a third plurality of composite plies, which plies have fibers extending in a second direction orthogonal to the first direction, to form a tube array 104. More particularly, the method 700 includes embedding the composite tubes 106, some or all of which may include composite joints 118, in the joining material 108 between the flowpath layer 110 and the outer layer 112. As previously described, the joining material 108 may comprise a plurality of individual composite plies 114 or filler packs 116 that fit around the composite tubes 106. For instance, the joining material 108 may comprise a plurality of individual rolled up composite plies 114, and the tubes 106 may be positioned on a bed of the rolled up plies 114 and more rolled up plies 114 may then be inserted around and over the tubes 106. As another example, one or more filler packs 116 may be fitted around each composite tube 106, e.g., a filler pack 116 may be shaped to conform to the outer surface 144 (or a portion of the outer surface 144) of a tube 106 and the number of filler packs 116 in the tube array 104 may be sufficient to surround the composite tubes 106 with the composite material forming the filler packs 116. The composite plies 114 forming the joining material 108 may be fitted around the composite tubes 106 in other ways as well.

Further, the flowpath layer 110 and the outer layer 112 each may comprise one or more composite plies 114 that are laid out in a generally flat or planar configuration, e.g., such that the flowpath layer 110 defines a relatively smooth combustion flowpath 102, with the joining material 108 and composite tubes 106 positioned therebetween. Thus, in some embodiments, the plies 114 forming one of the flowpath layer 110 and the outer layer 112 may be laid up on a tooling surface, the joining material 108 and tubes 106 may be laid up on the plies forming the layer 110 or layer 112, and then the other of the flowpath layer 110 and the outer layer 112 may be disposed on the joining material 108 and tubes 106. It will be appreciated that, as described above, a first plurality of composite plies 114 may be used to form the composite tubes 106, a second plurality of composite plies 114 may be used to form the joining material 108, and a third plurality of composite plies 114 may be used to form the flowpath layer 110 and the outer layer 112. Moreover, as previously described, in some embodiments, the composite plies 114 forming the composite tubes 106 may be laid up in +45°/−45° directions, the composite plies 114 forming the joining material 108 may be laid up generally along the 0° direction, and the composite plies 114 forming the flowpath and outer layers 110, 112 may be laid up generally along the 90° direction. Of course, in other embodiments, the plies 114 may be laid up in different or other directions for one or more of the segments 106, 108, 110, 112 of the tube array 104.

As depicted at block 714 in FIG. 7A, the exemplary method 700 further includes partially curing the tube array 104. As previously described, partially curing the tube array 104 may comprise autoclaving the tube array 104 to a temperature within a range of about 200° F. to about 500° F. until the tube array 104 is mostly cured. As discussed, partially curing the tube array 104 generally comprises curing the tube array 104 at a lower temperature, e.g., at a lower temperature than is used in a standard autoclave cycle. Thus, the partially cured tube array 104 may retain some flexibility and malleability, e.g., for joining the fasteners 128 to the tube array 104 as further described herein. Moreover, partially curing the tube array 104 may include compacting or debulking the composite material, such as the joining material 108 and the flowpath and outer layers 110, 112. For example, a flat plate autoclave tool may be used to compact the composite material and help produce a tube array 104 having a generally uniform cross-section. Further, the tooling may be relatively hard, floating tools for compacting the joining material 108, the flowpath layer 110, and the outer layer 112.

The exemplary method 700 continues at block 716 in FIG. 7B. As shown, the method 700 includes laying up a plurality of composite plies, such as composite plies 114, to form a plurality of composite fasteners 128. For instance, the method 700 may include laying up a plurality of CMC plies to form a plurality of CMC fasteners 128 as described herein. Like the tubes 106, joints 118, and tube array 104, the composite fasteners 128 may be partially cured, as shown at block 718 in FIG. 7B. As described herein, partially curing the fasteners 128 may comprise autoclaving the fasteners 128 to a lower temperature than a standard autoclave cycle, such as a temperature within a range of about 200° F. to about 500° F. until the fasteners 128 are mostly cured. As discussed herein, the partially cured fasteners 128 may retain some flexibility and malleability, e.g., for joining the fasteners 128 to the tube array 104 as further described herein.

As illustrated at block 720 of FIG. 7B, the exemplary method 700 further includes laying up hoop plies 140 about the head 134 of each fastener 128 positioned in contact with the tube array 104 to define the flowpath assembly 100. That is, the plurality of composite fasteners 128 are positioned in contact with the outer layer 112 of the tube array 104, then hoop plies 140 are laid up around the fasteners 128. As described in greater detail herein and illustrated in FIGS. 6A and 6B, the hoop plies 140 may be laid up local to each fastener 128 or may be laid up along the entire outer layer 112 of the tube array 104. The hoop plies 140 help join the fasteners 128 to the tube array 104 while also reinforcing the connection between the fasteners 128 and the outer layer 112 of the tube array 104.

As shown at block 722, after the hoop plies 140 are laid up around the composite fasteners 128 in contact with the tube array 104, the flowpath assembly 100 is cured. For example, the flowpath assembly 100 undergoes a complete autoclave process, e.g., a standard autoclave cycle at a temperature within a range of about 300° F. to about 500° F. Unlike the partial curing processes described above, the flowpath assembly 100, comprising the tube array 104 (including the composite tubes 106, composite joints 118, joining material 108, flowpath layer 110, and outer layer 112), the composite fasteners 128, and the hoop plies 140, is fully cured. After fully curing the flowpath assembly 100, the flowpath assembly 100 is processed as depicted at block 724. For instance, to process the assembly, the flowpath assembly 100 may be subjected to burnout and melt infiltration using the temperatures and methods described herein. More particularly, for a CMC flowpath assembly 100, the cured flowpath assembly 100 may be heated (fired) in a vacuum or inert atmosphere to decompose the binders, remove the solvents, and convert the precursor to the desired ceramic matrix material; this process may be referred to as burnout. Due to decomposition of the binders, the result for the preform is a porous CMC fired body that may undergo densification, e.g., melt infiltration (MI), to fill the porosity and yield the respective CMC component. In some embodiments, boron nitride (BN) or the like may be inserted within the composite tubes 106 to prevent the tubes 106 from filling with the infiltration material during melt infiltration. Processing the flowpath assembly 100 also may include applying a coating to one or more surfaces of the flowpath assembly 100, such as to the inner surface 148 of the flowpath layer 110, i.e., the surface facing or lining the combustion flowpath 102.

As described herein, in some embodiments, a high temperature liner layer 120 may be disposed on the inner surface 148 of the flowpath layer 110, e.g., to increase the temperature capability of the combustion flowpath 102. For instance, as described with respect to FIG. 4, a high temperature SiC/SiC liner layer 120 may be disposed on the flowpath layer 110 to increase the flowpath temperatures that the tube array 104 can withstand. In some embodiments, the liner layer 120 illustrated in FIG. 4 may be laid up with the composite plies 114 forming the flowpath layer 110, as part of the method 700 described with respect to block 712. That is, in some embodiments, the liner layer 120 may be laid up as part of the tube array 104 such that the liner layer 120 is cured and processed with the tube array 104.

In other embodiments, as described with respect to FIG. 5, the high temperature liner layer 120 comprises a woven material 122, such as woven plies or woven ceramic fiber cloth 122, and a coating 124. The liner layer 120 comprising woven material 122 and coating 124 may be added to the flowpath assembly 100 after processing as illustrated at block 724. More particularly, continuing with FIG. 7C, as shown at blocks 726 and 728, the method 700 may include spraying the inner surface 148 and/or the woven material 122 with an adhesive and disposing the woven material 122 on the inner surface 148. It will be appreciated that the spray adhesive secures the woven material 122 to the cured and processed flowpath assembly 100 to keep the woven material 122 in place.

Next, as shown at block 730, the flowpath assembly 100 and the woven material 122 adhered thereto are cured to more fully join the woven material 122 with the flowpath assembly 100. For example, the woven material 122 and the flowpath assembly 100 may be cured in an autoclave, e.g., using a standard autoclave cycle as described herein. Then, as shown at block 732, a chemical vapor infiltration (CVI) process is used to add a fiber interface to the woven material 122. CVI processes are described in greater detail elsewhere herein. The fiber interface may be boron nitride (BN) or the like deposited on the woven material 122 via a CVI boron nitride process. In some embodiments, the woven material 122 is pre-coated with BN or other fiber interface, such that the CVI BN process shown at block 732 can be omitted.

After the fiber interface is deposited on the woven material 122, or after curing the woven material 122 with the flowpath assembly 100 where block 732 may be omitted, a CVI process is used to infiltrate the woven material 122 as shown at block 734. For instance, for a SiC/SiC CMC flowpath assembly 100, a CVI process is used to infiltrate the woven material 122 with SiC and to bond the woven material 122 to the flowpath assembly 100 formed from the composite plies 114 as described herein (e.g., formed from prepreg composite plies 114). In some embodiments, as depicted at block 736, a coating 124 is added using a slurry process. More particularly, a slurry containing the coating material may be applied to the flowpath surface of the liner layer 120. As previously described, the coating 124 may be a carbide and/or oxide-based coating. Then, the flowpath assembly 100, including the woven material 122, is heat treated to convert the dried slurry on the flowpath surface to a finished coating, as shown at block 738. As described herein, the coating may be any suitable coating for providing increased environmental protection, e.g., by reducing oxidation or the like, to the flowpath assembly 100.

It will be appreciated that, as described herein, blocks 726 through 738 of method 700 describe optional steps for depositing a liner layer 120 on the flowpath layer 110 of the flowpath assembly 100, and that the processes described with respect to blocks 726 through 738 differ from the fabrication process culminating in melt infiltration described with respect to FIGS. 7A and 7B. As described with respect to FIGS. 4 and 5, the liner layer 120 may allow the flowpath assembly 100 to withstand higher combustion temperatures than with the flowpath layer 110 alone. However, in some embodiments, the flowpath layer 110 provides adequate temperature resistance and blocks 726 through 738 of the method 700 (i.e., the blocks illustrated in FIG. 7C) may be omitted.

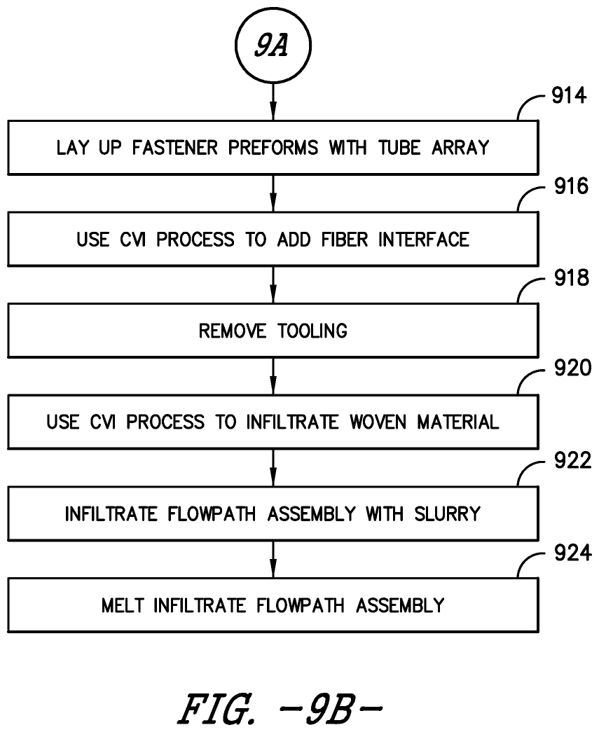

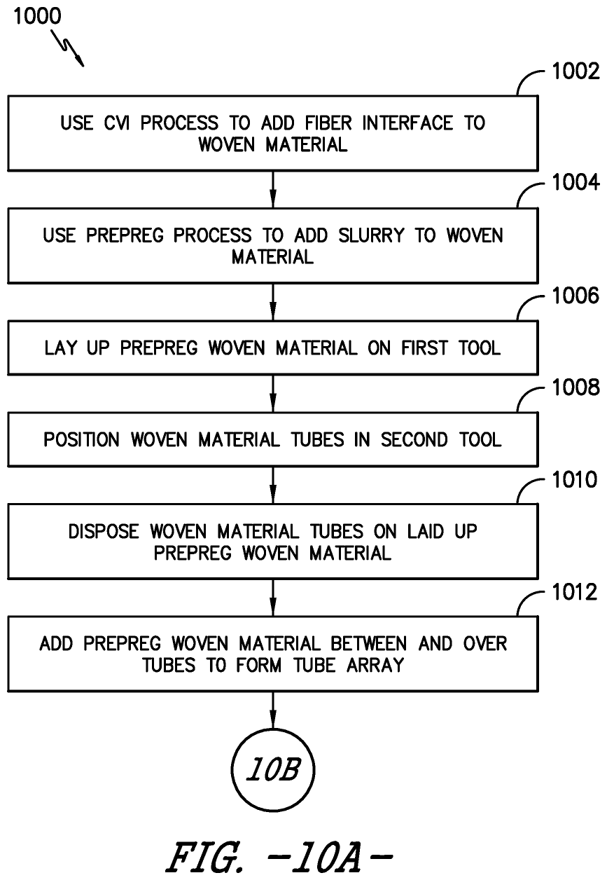

Turning now to FIGS. 9A and 9B, a flow diagram is provided illustrating a method 900 of forming a flowpath assembly, according to another exemplary embodiment of the present subject matter. More particularly, method 900 provides a CVI and slurry cast process for forming a composite flowpath assembly 100, such as a SiC/SiC flowpath assembly 100. As shown at block 902 in FIG. 9A, the exemplary method 900 includes laying up a woven material, such as composite cloth plies and/or composite fiber braids, with tooling to form a plurality of green preforms, each preform having the shape of a composite tube 106. For example, the woven material may be laid up around inner diameter (ID) tooling, e.g., ID graphite tools, to form tube preforms. In some embodiments, pre-made braided tube preforms may be purchased from a supplier, and the pre-made tube preforms assembled with the ID tooling, e.g., by sliding each tube preform over an ID tool or otherwise inserting the ID tool within the tube preform. A spray adhesive may be applied to adhere the composite tube preforms to the tooling. As shown at block 904 in FIG. 9A, the tube preforms and the tools disposed therein are vacuum bagged and cured, e.g., to stiffen the preforms.

Referring to block 906 in FIG. 9A, the exemplary method 900 also includes forming composite fasteners 128. More specifically, like the tube preforms, composite cloth plies and/or composite fiber braids may be laid up with graphite tools, such as graphite tools defining an outer diameter of the fasteners 128, to form a plurality of green preforms that each have the shape of a fastener 128. A spray adhesive may be applied to adhere the composite fastener preforms to the tooling. As shown at block 908 in FIG. 9A, the fastener preforms and the tooling defining the fastener shape are vacuum bagged and cured, e.g., to stiffen the preforms. It will be appreciated that the fastener preforms may be formed before, after, or simultaneously with the tube preforms.

As shown at block 910, the exemplary method 900 further includes embedding the tube preforms in the woven material (e.g., composite woven cloth plies and/or composite braided fiber plies) to form a tube array 104. As described with respect to method 700, embedding the tube preforms comprises disposing the tube preforms between woven material defining the flowpath layer 110 and woven material defining the outer layer 112, with woven material forming the joining material 108 surrounding the tube preforms between the flowpath and outer layers 110, 112. In an exemplary embodiment, woven material (e.g., SiC cloth plies) forming one of the flowpath layer 110 and the outer layer 112 is laid up on tooling (e.g., a graphite tool) and the tube preforms, with the ID tooling disposed therein, are positioned on top of the woven material forming flowpath layer 110 or outer layer 112. Then, woven material, such as cut pieces of SiC cloth, is added between and around the tube preforms. Finally, woven material (e.g., SiC cloth plies) is laid up on top of the tube preforms and woven material pieces to form the other of the flowpath layer 110 and the outer layer 112. Another tool may be disposed on top of the top layer of woven material, and additional tooling may be disposed on the sides of the layup to support the layup. As illustrated at block 912 in FIG. 9A, the layup defining the tube array 104 is vacuum bagged and cured to bond the various segments of the tube array 104, e.g., to bond the tube preforms to the joining material 108 (i.e., the cut pieces of woven material), to bond the tube preforms and/or the joining material 108 to the flowpath layer 110 and the outer layer 112, etc.

Referring to FIG. 9B, the method 900 further comprises laying up the composite fasteners 128 with the tube array 104, as shown at block 914. In some embodiments, as described with respect to method 700, laying up the composite fasteners 128 with the tube array 104 includes laying up hoop plies 140 about the head 134 of each fastener 128 positioned in contact with the tube array 104. That is, the plurality of composite fasteners 128 are positioned in contact with the outer layer 112 of the tube array 104, then hoop plies 140 are laid up around the fasteners 128. As described in greater detail herein and illustrated in FIGS. 6A and 6B, the hoop plies 140 may be laid up local to each fastener 128 or may be laid up along the entire outer layer 112 of the tube array 104. The hoop plies 140 help join the fasteners 128 to the tube array 104 while also reinforcing the connection between the fasteners 128 and the outer layer 112 of the tube array 104. It will be appreciated that, in such embodiments, the hoop plies 140 are formed from the woven material, e.g., the hoop plies 140 may be SiC cloth plies.

Further, laying up the fasteners 128 also includes adding tooling to support the fasteners 128 with respect to the tube array 104; the fasteners 128 also are supported by the outer diameter (OD) tools used to form the fasteners 128. It will be appreciated that each portion of the tooling used to support the flowpath assembly 100, such as graphite ID tools disposed in the tubes 106, graphite OD tools disposed about the fasteners 128, and flat graphite tools disposed against the flowpath layer 110 and the outer layer 112, may be machined to help define the shape of the portion of the flowpath assembly 100 in contact with the tooling. For example, each graphite tool may be machined such that the surface of the tool in contact with the woven material has a shape complementary to the desired shape of the portion of the flowpath assembly 100 formed by that woven material. Further, in exemplary embodiments, the tooling (e.g., each graphite tool) has openings or holes defined therethrough such that the CVI reaction gases can infiltrate the flowpath assembly preform as described below.

As shown at block 916 in FIG. 9B, the method 900 includes using a CVI process to add a fiber interface to the woven material preform defining the flowpath assembly 100. More particularly, the tooling (e.g., the graphite tools) and the flowpath assembly preform are installed in a CVI reactor, where a fiber interface such as boron nitride (BN) or the like is deposited on the woven material preform. As illustrated at block 918 of method 900, the tooling is removed after the CVI process adding the fiber interface. At this point in the fabrication of the flowpath assembly 100, the part is stiff and will retain its shape such that tooling is not required to support the part. In some embodiments, the woven material is pre-coated with BN or other fiber interface, such that the CVI BN process shown at block 916 can be omitted. In such embodiments, the tooling may be retained until after the CVI process described with respect to block 920.

As depicted at block 920, the exemplary method 900 further includes using a CVI process to infiltrate the woven material, e.g., with SiC for a SiC/SiC flowpath assembly 100 or with alternating layers of SiC and boron carbide (BC). The amount of infiltration during this CVI process may be optimized such that the flowpath assembly preform is not over-infiltrated during the CVI infiltration, which could lead to porosity in the completed flowpath assembly 100.

Referring to block 922, after CVI infiltration, the flowpath assembly preform is infiltrated with a slurry. Then, as shown at block 924, the flowpath assembly preform undergoes melt infiltration. It will be appreciated that the slurry has the precursors for the melt infiltration process. In exemplary embodiments, where the flowpath assembly 100 is a SiC/SiC component, the melt infiltration is silicon melt infiltration. During the silicon melt infiltration, the flowpath assembly preform is put in a vacuum furnace, silicon is added, and the temperature is increased to melt the silicon, which infiltrates the preform. At least some of the slurry powders are intended to react with the silicon to densify the flowpath assembly preform and form the final flowpath assembly 100.

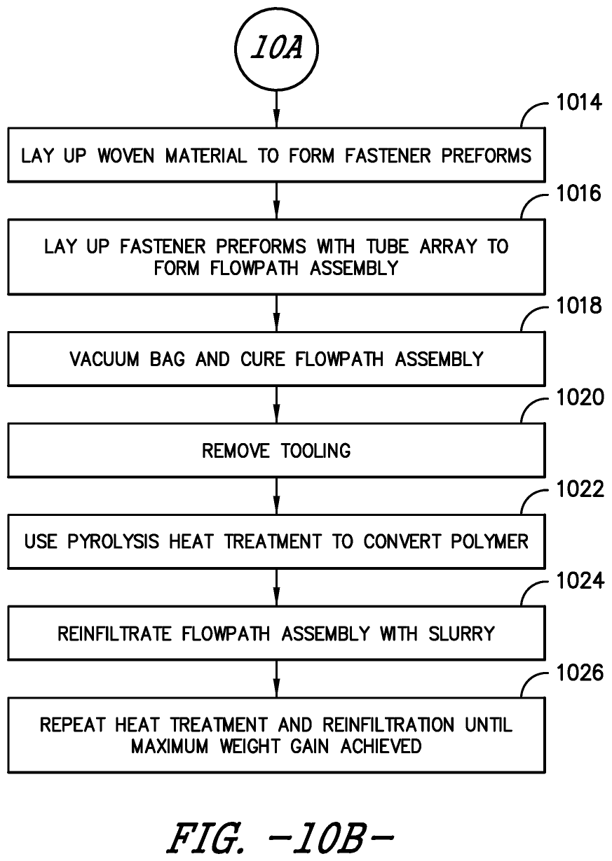

Referring now to FIGS. 10A and 10B, a flow diagram is provided illustrating a method 1000 of forming a flowpath assembly, according to another exemplary embodiment of the present subject matter. More particularly, method 1000 provides a polymer infiltration and pyrolysis (PIP) process for forming a composite flowpath assembly 100, such as a SiC/SiC flowpath assembly 100. For a SiC/SiC flowpath assembly 100, an exemplary PIP process uses woven SiC cloth and braided SiC fiber as the building blocks to make the SiC/SiC CMC, and the SiC cloth and braids have a fiber interface (e.g., boron nitride) applied thereon prior to any CMC fabrication. Thus, as shown at block 1002 in FIG. 10A, the exemplary method 1000 includes using a CVI process to add the fiber interface to the woven material.

Next, as shown at block 1004, a preceramic polymer/ceramic slurry is added to the woven material using a prepreg process. More particularly, woven cloth composite plies and/or composite fiber braids (such as SiC cloth and/or SiC braids) are laid up on tooling, e.g., metal tooling having a release agent thereon, to form a green preform having a desired shape. For instance, the woven composite material may be laid up on metal inner diameter (ID) tools with a release agent to form the composite tubes 106. The preceramic polymer/ceramic slurry is applied to the green preforms and dried to produce stiff parts. The preceramic polymer/ceramic slurry may comprise carbide particles, such as silicon carbide (SiC) particles or powder, boron carbide (BC) particles or powder, etc., which can help produce a denser final part.

As illustrated at blocks 1006 through 1012 in FIG. 10, the exemplary method 1000 then includes assembling the tube array 104. More specifically, at block 1006, prepreg woven material is laid up on a first tool. It will be appreciated that the prepreg woven material may define one of the flowpath layer 110 and the outer layer 112 and, therefore, the first tool may be substantially flat. Then, as shown at block 1008, the woven composite tubes 106 are positioned in second tools, e.g., split ID tools, and the tubes 106 and, as shown at block 1010, their tooling are disposed on the prepreg woven material laid up on the first tool. As illustrated at block 1012, more prepreg woven material is then added between the tubes 106, as joining material 108, and then a layer of prepreg woven material is laid up on top of the tubes 106 and joining material 108 to form the other of the flowpath layer 110 and the outer layer 112. Thus, the woven material layup, including the woven material defining the flowpath layer 110, the composite tubes 106, the joining material 108, and the outer layer 112, forms the tube array 104 as described herein.

Referring to block 1014 in FIG. 10B, the exemplary method 1000 also includes forming composite fasteners 128 as described with respect to methods 700 and 900. More particularly, woven material is laid up with tooling to define the shape of the composite fasteners 128. For example, braided composite fiber tubes and woven cloth may be disposed between two or more tools to form the shape of the composite fasteners 128.

As shown at block 1016, the composite fastener preforms, including the woven material defining the composite fasteners 128 and the tooling defining the shape of each fastener 128, are laid up with the tube array 104 to form the flowpath assembly 100. Then, as shown at block 1018, the flowpath assembly 100 is vacuum bagged at cured, e.g., in an autoclave in a standard autoclave pressure/temperature cycle. After curing, all tooling is removed from the flowpath assembly 100, as illustrated at block 1020 in FIG. 10B.

Referring to blocks 1022 through 1026, the flowpath assembly 100 is then subjected to heat treatments and repeated infiltration with slurry to prevent oxidation, convert the polymer to the ceramic material, and reduce porosity in the part. More particularly, as shown at block 1022, the flowpath assembly 100 is put in a controlled environment furnace, e.g., a vacuum furnace, which helps prevent oxidation, and a pyrolysis heat treatment is used to convert the polymer, e.g., to SiC or SiNC. Whether SiC or SiNC is formed depends on the maximum temperature used during the heat treatment. The polymer shrinks when it converts to SiC or SiNC, and significant porosity occurs. Thus, as shown at block 1024, the flowpath assembly 100 is reinfiltrated with polymer, and then, as shown at block 1026, the second infiltration is followed by another heat treatment. Heat treatment and infiltration are repeated until a maximum weight gain is achieved. That is, the final flowpath assembly 100 should be as dense as possible (with porosity reduced as much as possible), and multiple processing steps are used to achieve maximum density. For typical PIP processes, a total of about 6 to 10 polymer infiltration/heat treatment cycles are used to produce the final part. Further, as previously stated, carbide particles or powder may be added to the preceramic slurry to help achieve maximum density.

It will be appreciated that, although described with respect to the hypersonic vehicle 10 and ramjet 22, the flowpath assembly 100 and methods of forming a flowpath assembly 100 described herein may have other applications. That is, the flowpath assembly 100 is not limited to use with a ramjet or a hypersonic vehicle.

Accordingly, the present subject matter provides flowpath assemblies that can meet high flowpath temperatures, e.g., of hypersonic vehicles. More particularly, the flowpath assemblies described herein provide a composite tube array, such as a SiC/SiC CMC tube array, that delivers fuel and defines a high temperature combustion flowpath. The composite tubes are embedded into composite material, e.g., CMC panels, to provide a smooth flowpath for combustion products. Composite fasteners may be attached to the tube array that have the same coefficient of thermal expansion (CTE) as the tube array, thereby avoiding use of metallic fasteners having a CTE mismatch with the composite tube array and which could react with the composite material and degrade both the metallic fastener material and the composite material. As described herein, flowpath assemblies may be formed that can be subjected to flowpath temperatures above 1500° F., more particularly above 2000° F., such as 2400° F. or above. Further, the present subject matter also includes various methods of forming such flowpath assemblies, increasing flexibility in manufacturing and allowing optimization of the manufacture of the flowpath assemblies described herein. Other benefits and advantages of the systems described herein also may occur to those having ordinary skill in the art.

Further aspects of the invention are provided by the subject matter of the following clauses:

1. A flowpath assembly for a combustor comprising a tube array comprising a plurality of tubes, a joining material disposed between adjacent tubes of the plurality of tubes to join together the adjacent tubes, a flowpath layer, and an outer layer, the plurality of tubes and the joining material disposed between the flowpath layer and the outer layer, wherein the flowpath layer defines a combustion flowpath, and wherein each of the plurality of tubes, the joining material, the flowpath layer, and the outer layer are formed from a composite material.

2. The flowpath assembly of any preceding clause, wherein the tube array comprises a first tube array and a second tube array, the plurality of tubes divided between the first tube array and the second tube array, and wherein the first tube array is spaced apart from the second tube array such that the combustion flowpath is defined therebetween.

3. The flowpath assembly of any preceding clause, wherein the tube array comprises a plurality of composite joints for joining the plurality of tubes of the first tube array to the plurality of tubes of the second tube array, and wherein the plurality of composite joints are formed separately from the plurality of tubes.

4. The flowpath assembly of any preceding clause, wherein the joining material comprises a plurality of individual composite plies.

5. The flowpath assembly of any preceding clause, wherein the joining material comprises a plurality of filler packs.

6. The flowpath assembly of any preceding clause, wherein the joining material comprises a first plurality of fibers and the flowpath layer and the outer layer comprise a second plurality of fibers, and wherein the first plurality of fibers are disposed orthogonal to the second plurality of fibers.

7. The flowpath assembly of any preceding clause, wherein the composite material is a ceramic matrix composite (CMC) material.

8. The flowpath assembly of any preceding clause, wherein the flowpath layer is made from a CMC material capable of withstanding temperatures at or above 2000° F.

9. The flowpath assembly of any preceding clause, wherein the flowpath layer is made from a CMC material capable of withstanding temperatures at or above 2400° F.

10. The flowpath assembly of any preceding clause, wherein the tube array further comprises a liner layer comprising a SiC/SiC composite material, the liner layer disposed on the flowpath layer such that the flowpath layer is positioned between the liner layer and the plurality of tubes, and wherein the liner layer is capable of withstanding higher temperatures than the composite material from which the flowpath layer is made.

11. The flowpath assembly of any preceding clause, wherein the tube array further comprises a liner layer comprising a woven ceramic fiber cloth and an environmental barrier coating, the liner layer disposed on the flowpath layer such that the flowpath layer is positioned between the liner layer and the plurality of tubes, and wherein the liner layer is capable of withstanding higher temperatures than the composite material from which the flowpath layer is made.

12. The flowpath assembly of any preceding clause, further comprising a metallic back structure, wherein the metallic back structure is coupled to the tube array adjacent the outer layer such that the tube array is disposed between the metallic back structure and the flowpath.

13. The flowpath assembly of any preceding clause, further comprising a plurality of CMC fasteners for coupling the metallic back structure to the tube array.

14. The flowpath assembly of any preceding clause, wherein a plurality of hoop plies join each CMC fastener of the plurality of CMC fasteners to the outer layer.

15. The flowpath assembly of any preceding clause, wherein a plurality of hoop plies is formed from a CMC material.

17. The flowpath assembly of any preceding clause, wherein each tube of the plurality of tubes is formed from a SiC/SiC CMC material.

18. The flowpath assembly of any preceding clause, wherein the plurality of tubes are configured for injecting fuel into the combustor, and wherein the combustor is a ramjet engine combustor.

19. A method of forming a flowpath assembly comprising laying up a plurality of composite plies to form a plurality of composite tubes; partially curing the plurality of composite tubes; embedding the plurality of composite tubes in an assembly of first composite plies having fibers extending in a first direction and second composite plies having fibers extending in a second direction to form a tube array, the first direction orthogonal to the second direction; and partially curing the tube array.

20. The method of any preceding clause, wherein partially curing the plurality of composite tubes comprises autoclaving the plurality of composite tubes to a temperature within a range of about 200° F. to about 500° F. until the plurality of composite tubes are mostly cured, and wherein partially curing the tube array comprises autoclaving the tube array to a second temperature within a second range of about 200° F. to about 500° F. until the tube array is mostly cured.

21. The method of any preceding clause, wherein partially curing the plurality of composite tubes comprises compacting the plurality of composite tubes.

22. The method of any preceding clause, wherein each composite tube of the plurality of composite tubes is disposed on an internal tool having a bladder and disposed within an external tool fitting around an outer surface of the composite tube, and wherein the bladder expands against an inner surface of the composite tube to compact the composite tube.

23. The method of any preceding clause, further comprising laying up a plurality of composite plies to form a plurality of composite tube joints; partially curing the plurality of tube joints; and assembling the plurality of tube joints with the plurality of composite tubes.

24. The method of any preceding clause, further comprising laying up a plurality of composite plies to form a plurality of composite fasteners; laying up the plurality of composite fasteners with the partially cured tube array; and curing the plurality of fasteners and the partially cured tube array.

25. The method of any preceding clause, wherein laying up the plurality of composite fasteners with the partially cured tube array comprises laying up hoop plies around each composite fastener of the plurality of composite fasteners.

26. The method of any preceding clause, wherein the hoop plies surround a head of each composite fastener.

27. The method of any preceding clause, wherein the head of each composite fastener flares from a smaller diameter at a shaft of the composite fastener to a larger diameter at a proximal end of the composite fastener.

28. The method of any preceding clause, wherein the composite plies are formed from a ceramic matrix composite (CMC) material such that the plurality of composite tubes is a plurality of CMC tubes.

29. The method of any preceding clause, wherein the hoop plies are formed from a CMC material.

30. The method of any preceding clause, further comprising processing the tube array.

31. The method of any preceding clause, wherein processing the tube array comprises firing and densifying the tube array.

32. The method of any preceding clause, wherein densifying the tube array comprises melt infiltrating the composite plies with silicon to form a SiC/SiC tube array.

33. The method of any preceding clause, further comprising laying up a liner layer on a flowpath surface of the tube array; curing the liner layer and the tube array; and firing and densifying the liner layer and the tube array.

34. The method of any preceding clause, further comprising firing and densifying the tube array; laying up a woven material on a flowpath surface of the tube array; using a chemical vapor infiltration (CVI) process to bond the woven material to the tube array; infiltrating the woven material and the tube array with a slurry; and melt infiltrating the woven material and the tube array.

35. The method of any preceding clause, wherein laying up the woven material on the flowpath surface comprises spraying an adhesive on the woven material or the flowpath surface and disposing the woven material on the flowpath surface.

36. A method of forming a flowpath assembly comprising laying up a woven material with tooling to form tube preforms; curing the tube preforms; embedding the tube preforms in woven material to form a tube array; curing the tube array; and using a CVI process to infiltrate the woven material and form the flowpath assembly.

37. The method of any preceding clause, further comprising laying up woven material to form fastener preforms; curing the fastener preforms; and laying up the fastener preforms with the tube array prior to using the CVI process.

38. The method of any preceding clause, wherein the CVI process is a second CVI process, and further comprising using a first CVI process to add a fiber interface to the tube array and removing the tooling prior to using the second CVI process.

39. The method of any preceding clause, further comprising infiltrating the flowpath assembly with a slurry and melt infiltrating the flowpath assembly.

40. A method of forming a flowpath assembly comprising laying up prepreg woven material on a first tool; positioning woven material tubes in a second tool; disposing the woven material tubes on the prepreg woven material; adding pieces of prepreg woven material between and over the woven material tubes to form a tube array; curing the tube array; using a polymer infiltration and pyrolysis (PIP) process to densify the tube array.

41. The method of any preceding clause, further comprising using a CVI process to add a fiber interface to a woven material prior to laying up the prepreg woven material.

42. The method of any preceding clause, further comprising using a prepreg process to add slurry to the woven material to form the prepreg woven material.

43. The method of any preceding clause, further comprising laying up woven material to form fastener preforms; laying up the fastener preforms with the tube array to form the flowpath assembly; curing the flowpath assembly.

44. The method of any preceding clause, wherein curing the flowpath assembly comprises vacuum bagging the flowpath assembly.

45. The method of any preceding clause, wherein the first tool and the second tool are removed after curing.

46. The method of any preceding clause, wherein the PIP process includes using a pyrolysis heat treatment to convert a polymer in the prepreg woven material, reinfiltrating the flowpath assembly with a slurry, and repeating the heat treatment and reinfiltration to achieve a maximum weight gain of the flowpath assembly.

47. A hypersonic vehicle comprising a ramjet engine comprising an inlet, a nozzle, a fuel delivery system comprising a fuel tank, and a combustor disposed between the inlet and the nozzle, the fuel delivery system providing a flow of a fuel to the combustor, the combustor including a flowpath assembly for combustion of the fuel and a flow of combustion products therealong, the flowpath assembly comprising a tube array comprising a plurality of tubes, a joining material disposed between adjacent tubes of the plurality of tubes to join together the adjacent tubes, a flowpath layer, and an outer layer, the plurality of tubes and the joining material disposed between the flowpath layer and the outer layer, wherein the flowpath layer defines a combustion flowpath, and wherein each of the plurality of tubes, the joining material, the flowpath layer, and the outer layer are formed from a composite material.

48. The hypersonic vehicle of any preceding clause, wherein the composite material is a ceramic matrix composite (CMC) material.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A flowpath assembly for a combustor, comprising:
a tube array comprising a plurality of tubes, a joining material disposed between adjacent tubes of the plurality of tubes to join together the adjacent tubes, a flowpath layer, and an outer layer, the plurality of tubes and the joining material disposed between the flowpath layer and the outer layer,
wherein the flowpath layer defines a combustion flowpath, and
wherein each of the plurality of tubes, the joining material, the flowpath layer, and the outer layer are formed from a composite material.

2. The flowpath assembly of claim 1, wherein the tube array comprises a first tube array and a second tube array, the plurality of tubes divided between the first tube array and the second tube array, and wherein the first tube array is spaced apart from the second tube array such that the combustion flowpath is defined therebetween.

3. The flowpath assembly of claim 2, wherein the tube array comprises a plurality of composite joints for joining the plurality of tubes of the first tube array to the plurality of tubes of the second tube array, and wherein the plurality of composite joints are formed separately from the plurality of tubes.

4. The flowpath assembly of claim 1, wherein the joining material comprises a plurality of individual composite plies.

5. The flowpath assembly of claim 1, wherein the joining material comprises a plurality of filler packs.

6. The flowpath assembly of claim 1, wherein the joining material comprises a first plurality of fibers and the flowpath layer and the outer layer comprise a second plurality of fibers, and wherein the first plurality of fibers are disposed orthogonal to the second plurality of fibers.

7. The flowpath assembly of claim 1, wherein the flowpath layer is made from a ceramic matrix composite (CMC) material capable of withstanding temperatures at or above 2000° F.

8. The flowpath assembly of claim 7, wherein the tube array further comprises a liner layer comprising a SiC/SiC CMC material, the liner layer disposed on the flowpath layer such that the flowpath layer is positioned between the liner layer and the plurality of tubes, and wherein the liner layer is capable of withstanding higher temperatures than the CMC material from which the flowpath layer is made.

9. The flowpath assembly of claim 7, wherein the tube array further comprises a liner layer comprising a woven ceramic fiber cloth and an environmental barrier coating, the liner layer disposed on the flowpath layer such that the flowpath layer is positioned between the liner layer and the plurality of tubes, and wherein the liner layer is capable of withstanding higher temperatures than the CMC material from which the flowpath layer is made.

10. The flowpath assembly of claim 1, further comprising:
a metallic back structure,
wherein the metallic back structure is coupled to the tube array adjacent the outer layer such that the tube array is disposed between the metallic back structure and the flowpath, and
wherein the composite material is a ceramic matrix composite (CMC) material.

11. The flowpath assembly of claim 10, further comprising:
a plurality of CMC fasteners for coupling the metallic back structure to the tube array.

12. The flowpath assembly of claim 11, wherein a plurality of hoop plies join each CMC fastener of the plurality of CMC fasteners to the outer layer.

13. The flowpath assembly of claim 1, wherein each tube of the plurality of tubes is formed from a SiC/SiC CMC material.

14. The flowpath assembly of claim 1, wherein the plurality of tubes are configured for injecting fuel into the combustor, and wherein the combustor is a ramjet engine combustor.

15. A method of forming a flowpath assembly, comprising:
laying up a plurality of composite plies to form a plurality of composite tubes;
partially curing the plurality of composite tubes;
embedding the plurality of composite tubes in an assembly of first composite plies having fibers extending in a first direction and second composite plies having fibers extending in a second direction to form a tube array, the first direction orthogonal to the second direction; and
partially curing the tube array.

16. The method of claim 15, wherein partially curing the plurality of composite tubes comprises autoclaving the plurality of composite tubes to a temperature within a range of about 200° F. to about 500° F. until the plurality of composite tubes are mostly cured, and wherein partially curing the tube array comprises autoclaving the tube array to a second temperature within a second range of about 200° F. to about 500° F. until the tube array is mostly cured.

17. The method of claim 15, wherein the composite plies are ceramic matrix composite (CMC) plies such that the composite tubes are CMC tubes, the method further comprising:
laying up a plurality of CMC plies to form a plurality of CMC fasteners;
laying up the plurality of CMC fasteners with the partially cured tube array; and
curing the plurality of CMC fasteners and the partially cured tube array.

18. The method of claim 15, further comprising:
laying up a liner layer on a flowpath surface of the tube array;
curing the liner layer and the tube array; and
firing and densifying the liner layer and the tube array.

19. The method of claim 15, further comprising:
firing and densifying the tube array;
laying up a woven material on a flowpath surface of the tube array;
using a chemical vapor infiltration process to bond the woven material to the tube array;
infiltrating the woven material and the tube array with a slurry; and
melt infiltrating the woven material and the tube array.

20. A hypersonic vehicle, comprising:
a ramjet engine comprising an inlet, a nozzle, a fuel delivery system comprising a fuel tank, and a combustor disposed between the inlet and the nozzle, the fuel delivery system providing a flow of a fuel to the combustor, the combustor including a flowpath assembly for combustion of the fuel and a flow of combustion products therealong, the flowpath assembly comprising:
a tube array comprising a plurality of tubes, a joining material disposed between adjacent tubes of the plurality of tubes to join together the adjacent tubes, a flowpath layer, and an outer layer, the plurality of tubes and the joining material disposed between the flowpath layer and the outer layer, wherein the flowpath layer defines a combustion flowpath, and
wherein each of the plurality of tubes, the joining material, the flowpath layer, and the outer layer are formed from a composite material.
